(19) United States
(12) Patent Application Publication
(10) Pub. No.: US 2014/0119488 A1
(43) Pub. Date: May 1, 2014

(54) NUCLIDE TRANSMUTATION DEVICE AND NUCLIDE TRANSMUTATION METHOD

(71) Applicant: MITSUBISHI HEAVY INDUSTRIES, LTD., Minato-ku (JP)

(72) Inventors: Yasuhiro IWAMURA, Yokohama-shi (JP); Takehiko Itoh, Yokohama-shi (JP); Mitsuru Sakano, Yokohama-shi (JP)

(73) Assignee: MITSUBISHI HEAVY INDUSTRIES, LTD., Minato-ku (JP)

(21) Appl. No.: 14/077,942

(22) Filed: Nov. 12, 2013

Related U.S. Application Data
(63) Continuation of application No. 13/483,921, filed on May 30, 2012.
Application No. 13/483,921 is a continuation of application No. 10/373,723, filed on Feb. 27, 2003, now abandoned.
Application No. 10/373,723 is a division of application No. 09/981,983, filed on Oct. 19, 2001, now abandoned.

(30) Foreign Application Priority Data
Oct. 31, 2000 (JP) 2000-333640
Jul. 3, 2001 (JP) 2001-201875

(51) Int. Cl. G21G 1/04

(52) U.S. Cl. CPC G21G 1/04
USPC 376/199

(57) ABSTRACT

The present invention produces nuclide transmutation using a relatively small-scale device. The device 10 that produces nuclide transmutation comprises a structure body 11 that is substantially plate shaped and made of palladium (Pd) or palladium alloy, or another metal that absorbs hydrogen (for example, Ti) or an alloy thereof, and a material 14 that undergoes nuclide transmutation laminated on one surface 11A among the two surfaces of this structure body 11. The one surface 11 A side of the structure body 11, for example, is made a region in which the pressure of the deuterium is high due to pressure or electrolysis and the like, and the other surface 11B side, for example, is a region in which the pressure of the deuterium is low due to vacuum exhausting and the like, arid thereby, a flow of deuterium in the structure body 11 is produced, and nuclide transmutation is carried out by a reaction between the deuterium and the material 14 that undergoes nuclide transmutation.

### CROSS REFERENCES

This application is a continuation of U.S. Ser. No. 13/483,921 filed May 30, 2012. U.S. Ser. No. 13/483,921 is a continuation of Ser. No. 10/373,723 filed Feb. 27, 2003, which is a divisional of U.S. Ser. No. 09/981,983 filed Oct. 19, 2001, the entire contents of each are incorporated herein by reference, and claims the benefit of priority under 35 U.S.C. §119 from Japanese Patent Application Nos. P2000-333640 filed Oct. 31, 2000 and P2001-201875 filed Jul. 3, 2001.

### BACKGROUND OF THE INVENTION

1. Field of the Invention

The present invention relates to a nuclide transmutation device and a nuclide transmutation method associated, for example, with disposal processes in which long-lived radioactive waste is transmuted into short-lived radioactive nuclides or stable nuclides, and technologies that generate rare earth elements from abundant elements found in the natural world.

2. Description of the Related Art

Conventional disposal processes are known that include, for example, methods in which large amounts of long-lived radioactive nuclides included in high level radioactive waste and the like are efficiently and effectively transmuted in a short time. Examples of these methods are those in which small amounts of nuclide are transmuted, such as heavy element synthesis by a nuclear fusion reaction using a heavy ion accelerator.

These disposal processes are nuclide transmutation processes in which minor actinides such as Np, Am, and Cm included in high level radioactive waste, long-lived radioactive products of nuclear fission such as Tc-99 and 1-129, exothermic Sr-90 and Cs-137, and useful platinum group elements such as Rh and Pd are separated depending on the properties of each of the elements (group separation), and subsequently causing a nuclear reaction by desorption of neutrons, the minor actinides having a long half-life and nuclear fission products, and transmuted into short-lived radioactive or non-radioactive nuclides. In addition, the useful elements and the long-lived radioactive nuclides included in the high level radioactive waste are separated and recovered, effective use of the elements is implemented, and at the same time, long-lived radioactive nuclides are transmuted into short-lived radioactive or stable nuclides.

Three types of disposal processing methods are known: disposal processing for actinides and the like by neutron irradiation in a nuclear reactor such as a fast breeder reactor or an actinide burn reactor; nuclear spallation processing for actinides and the like by neutron irradiation in an accelerator, and disposal processing of cesium, strontium, and the like by gamma ray irradiation in an accelerator.

By neutron irradiation in a nuclear reactor, minor actinides, which have a large neutron interaction cross-section, can be rationally processed, and in particular, by irradiation with fast neutrons, transuranic elements, whose nuclear fission is difficult to cause, can be directly caused to undergo nuclear fission.

However, long-lived radioactive nuclear fission products are difficult to process by neutron irradiation in a nuclear reactor and the like, and for example, for Sr-90, Cs-137 and the like, which have a small neutron interaction cross section, disposal processing using an accelerator is applied.

In a disposal process using an accelerator, because unlike a nuclear reactor they are operated subcritically, the safety in relation to criticality is superior, and there is the advantage that there is a large degree of design freedom, and proton accelerators and electron beam accelerators are used.

In disposal processing using a proton accelerator, a nuclear spallation reaction is used in which high energy protons at, for example, 500 MeV to 2 GeV, are irradiated to spall the target nucleus, and nuclide transmutation is caused directly by using the nuclear spallation reaction. In addition, a nuclear fission reaction is generated by injecting the plurality of neutrons generated along with spallation of the target nucleus into a subcritical blanket placed around the target nuclei, and a nuclide transmutation reaction is generated by a neutron capture interaction. Thereby, for example, transuranic elements such as neptunium and americium and long-lived radioactive nuclear fission products can be disposed of, and furthermore, the heat generated by the subcritical blanket can be recovered and used for power generation, and the power necessary to operate to the proton accelerator can be made self-sufficient.

In addition, in disposal processing using an electron accelerator, disposal processing of long-lived radioactive nuclear fission products such as strontium and cesium and the transuranic elements and the like can be carried out by using gamma radiation generated by the bremsstrahlung of the proton beam or a large resonance reaction such as a photonuclear reaction, for example, the (γ, N) reaction and the (γ, nuclear fission) reaction, using gamma radiation and the like generated by a reverse Compton scattering by combining, for example, an electron accumulating ring and an optical cavity.

However, in the case of carrying out nuclide transmutation using a nuclear reactor or an accelerator, as in the disposal processes in the above-described examples of conventional technology, there are the problems in that large-scale and high cost apparatuses must be used, and the cost required for the nuclide transmutation increases drastically.

Furthermore, in the case of processing, for example, Cs-137, which is a long-lived radioactive nuclide fission product, when transmutating Cs-137 radiated from an electron power generator of about one million KW to another nuclide using an accelerator, there are problems in that the necessary power reaches one million KW and a high strength and large current accelerator become necessary, and thus efficiency is low.

In addition, in contrast to a thermal neutron flux of about 1×10¹⁴/cm²/sec in a nuclear reactor such as a light water reactor, the neutron flux necessary for nuclide transmutation of Cs-137, which has a small neutron interaction cross section, is about 1×10¹⁷-1×10¹⁸/cm²/sec, and there is the problem in that the necessary neutron flux cannot be attained.

### SUMMARY OF THE INVENTION

In consideration of the above-described circumstances, it is an object of the present invention to provide a nuclide transmutation device and a nuclide transformation method that can carry out nuclide transmutation with a relatively small-scale device compared to the large-scale devices such as accelerators and nuclear reactors.

In order to attain the object related to solving the problems described above, the nuclide transmutation device according to a first aspect of the invention comprises a structure body (the structure body 11, the multilayer structure body 32, the cathode 72, the multilayer structure body 89, the multilayer structure body 102 in the embodiments) that is made of palladium or a palladium alloy, or a hydrogen absorbing metal other than palladium, or a hydrogen absorbing alloy other than a palladium alloy, an absorbing part (the absorbing chamber 31, the absorbing chamber 103, or the electrolytic cell 83 in the embodiments) and a desorption part (the desorption chamber 34, the desorption part 101, or the vacuum container 85 in the embodiments) that are disposed so as to surround the structure body on the sides and form a closed space that can be sealed by the structure body, a high pressurization device (the deuterium tank 35, the deuterium tank 106, or the power source 81 in the embodiments) that makes the absorption part side on the side of the surface of the structure body have a state wherein the pressure of the deuterium is relatively high, a low pressurization device (the turbo-molecular pumps 38 and 110, the rotary pumps 39 and 111, and a vacuum exhaust pump 91 in the embodiments) that makes the desorption part side on the other side of the surface of the structure body have a state wherein the pressure of the deuterium is relatively low, and a transmutation material binding device (the step S22, the step S44, or the step S04a, in the embodiments) that binds the material that undergoes nuclide transmutation on one surface of the structure body material (¹³³Cs, ¹²C, and ²³Na in the embodiments) that undergoes nuclide transmutation on the one of the surface of the structure body.

According to the nuclide transmutation device having the structure described above, a pressure differential in the deuterium between the one surface and the other surface of the structure body is provided in a state wherein the material that undergoes nuclide transmutation is bound to one of the surfaces of the structure body serving as a multilayer structure, and within the structure body a flux of deuterium from one surface side to the other surface side is produced, and thereby an easily reproducible nuclide transmutation reaction can be produced for the deuterium and the material that undergoes nuclide transmutation.

Furthermore, the nuclide transmutation device according to a second aspect of the present invention is characterized in comprising a high pressurization device that provides a deuterium supply means (the deuterium tanks 35 and 106 in the embodiments) that supplies deuterium gas to the absorption part, and the low pressurization device provides an exhaust means (the turbo-molecular pumps 38 and 110, and the rotary pumps 39 and 111 in the embodiments) that brings about a vacuum state in the desorption part.

According to the nuclide transmutation device having the structure described above, the absorption part is pressurized by the deuterium supply device, and at the same time, the pressure in the radiation part is reduced to a vacuum state by the exhaust means, and thus a pressure differential in the deuterium is formed in the structure body.

Furthermore, the nuclide transmutation device according to a third aspect is characterized in the high pressurization device providing an electrolysis device (the power source 81 in the embodiments) that supplies an electrolytic solution (the electrolytic solution 84 in the embodiments) that includes deuterium to the absorption part and electrolyzes the electrolytic solution with the structure body serving as the cathode, and the lower pressurization device provides an exhaust device (the vacuum exhaust pump 91 in the embodiments) that brings about a vacuum state in the radiation part.

According to the nuclide transmutation device having the structure described above, by electrolyzing the electrolytic solution on one surface of the structure body with the structure body serving as a cathode, deuterium is absorbed effectively into the structure body due to the high pressure, and by reducing the pressure of the radiation part to a vacuum state using the exhaust device, a pressure differential in the deuterium is formed in the structure body.

Furthermore, the nuclide transmutation device according to a fourth aspect of the present invention is characterized in the transmutation material binding device providing a transmutation material lamination device (step S04, step S44, or step S04a, in the embodiments) that laminates the material that undergoes nuclide transmutation onto one surface of the structure body.

According to the nuclide transmutation device having the structure described above, the transmutation material lamination means can laminate the material that undergoes the nuclear transmutation on one surface of the structure body by a surface forming process, such as electrodeposition, vapor deposition, or sputtering.

Furthermore, the nuclide transmutation device according to a fifth aspect of the present invention is characterized in the transmutation material binding device providing a transmutation material supply means (step S22 in the embodiments) that supplies a material that undergoes nuclide transmutation in the absorption part, and exposing one surface of the structure body to a gas or liquid that includes the material that undergoes the nuclide transmutation.

According to the nuclide transmutation device having the structure described above, the material that undergoes nuclide transmutation can be bound to one surface of the structure body by mixing the material that undergoes nuclide transmutation in, for example, a gas or liquid that includes deuterium.

Furthermore, the nuclide transmutation device according to the sixth aspect of the present invention is characterized in that the structure body provides from one surface to the other surface in order a base material (the Pd substrate 23 in the embodiments) that is made of palladium or a palladium alloy, or a hydrogen absorbing metal other than palladium, or a hydrogen absorbing alloy other than a palladium alloy; a mixed layer (the mixed layer 22 in the embodiments) that is formed on the surface of the base material and comprises palladium or a palladium alloy, or a hydrogen absorbing metal other than palladium or a hydrogen absorbing alloy other than a palladium alloy, and a material having a low work function (CaO in the embodiments); and a surface layer (the Pd layer 21 in the embodiments) that is formed on the surface of the mixed layer and comprises palladium or a palladium alloy, or a hydrogen absorbing metal other than palladium or a hydrogen absorbing alloy other than a palladium alloy.

According to the nuclide transmutation device having the structure described above, a mixed layer that includes a material having a low work function is provided on the structure body that serves as the multilayer structure, and thereby the repeatability of the production of the nuclide transmutation reaction is improved.

According to the nuclide transmutation device having the structure described above, the production of the nuclide transmutation reaction can be further promoted by transmuting the material that undergoes nuclide transmutation to a nuclide having a similar isotope ratio composition.

In addition, the nuclide transmutation method according to a seventh aspect of the present invention is characterized in including in the structure body (the structure body 11, the structure body 32, multilayer structure body 32, the cathode 72, the multilayer structure body 89, and multilayer structure body 102 in the embodiments) comprising palladium or a palladium alloy, or a hydrogen absorbing metal other than palladium, or a hydrogen absorbing alloy other than a palladium alloy, a high pressurizing process (step S07, step S25, or step S46 in the embodiments) that brings about a state in which the pressure of the deuterium is relatively high on one surface side of the structure body, a low pressurizing process (step S05, step S23, or step S45 in the embodiments) that brings about a state in which the pressure of the deuterium is relatively low on the other surface side of the structure body, and a transmutation material binding process (step S 04 and step S 22 or steps S44 and S04a in the embodiments) that binds the material that undergoes nuclide transmutation to the one surface of the structure body.

According to the nuclide transmutation method described above, a pressure differential in the deuterium is provided between the one surface side and the other surface side of the structure body in a state in which the material that undergoes nuclide transmutation is bound to the one surface of the structure body that serves as the multilayer structure, and a flux of deuterium from the one surface side to the other surface side in the structure body is produced, and thereby the nuclide transmutation reaction is produced with good repeatability for the deuterium and the material that undergoes nuclide transmutation.

Furthermore, a nuclide transmutation method according to the eighth aspect of the present invention is characterized in the transmutation material binding process including either a transmutation material lamination process (step S04, step S44, or step S04a in the embodiments) that laminates the material that undergoes nuclide transmutation on the one surface of the structure body, or a transmutation material supply process (step S22 in the embodiments) that exposes the one surface of the structure body to a gas or liquid that includes the material that undergoes nuclide transmutation.

According to the nuclide transmutation method described above, a material that undergoes nuclide transmutation is laminated on the one surface of the structure body by a film formation process using a transmutation material lamination process such as electrodeposition, vaporization deposition, or sputtering, or the material that undergoes nuclide transmutation is mixed with a gas or liquid that includes deuterium and the like, and thereby the material that undergoes the nuclide transmutation are disposed on the one surface of the structure body.

Furthermore, a nuclide transmutation method according to a ninth aspect of the present invention is characterized in the transmutation material binding process that binds the material that undergoes nuclide transmutation to the one surface of the structure body.

According to the nuclide transmutation method described above, the material that undergoes nuclide transmutation is transmuted to a nuclide having a similar isotopic ratio composition, and thereby the nuclide transmutation reaction can be promoted.

### BRIEF DESCRIPTION OF THE DRAWINGS

FIG. 1 is a drawing for explaining the principle of the nuclide transmutation method according to the first embodiment of the present invention.

FIG. 2 is a cross-sectional structural drawing showing the structure body used in the nuclide transmutation method according to the first embodiment of the present invention.

FIG. 3 is a structural diagram of the nuclide transmutation device according to the first embodiment of the present invention.

FIG. 4 is s cross-sectional structure drawing of the multilayer structure body used in the nuclide transmutation device shown in FIG. 3.

FIG. 5A is a cross-sectional structural drawing of the mixed layers and FIG. 5B is a cross-sectional structural drawing of the structure body including the mixed layer.

FIG. 6 is a structural diagram of the device that adds a material to be subjected to the nuclide transmutation to the multilayer structure body.

FIG. 7 is a graph showing the spectra of Pr by XPS in on the surface of the multilayer structure body shown in FIG. 4.

FIGS. 8A and 8B are graphs showing the change in the number of Cs and Pr atoms over time on the surface of the multilayer structure body shown in FIG. 5.

FIG. 9 is a graph showing the change in the number of atoms for each of C, Mg, Si, and S over time on the surface of the multilayer structure body in the third embodiment.

FIG. 10 is a graph showing the change in the number of atoms for each of C, Mg, Si, and S over time on the surface of the multilayer structure body in the fourth embodiment.

FIG. 11 is a cross-sectional structure showing a multilayer structure body according to the second modified embodiment of the present invention.

FIG. 12 is a graph showing an XPS spectrum of Mo on the surface of the multilayer structure body shown in FIG. 11.

FIG. 13 is a graph showing the change in the number of Sr and Mo atoms over time on the surface of the multiplayer structure body shown in FIG. 11.

FIG. 14 is a graph showing the change in the number of Sr and Mo atoms over time on the multiplayer structure body shown in FIG. 11.

FIG. 15 is a graph showing the change of the isotopic ratio of the natural Mo with the change of the atomic mass number over time.

FIG. 16 is a graph showing the change of the isotopic ratio of the nucleated Mo on the surface of the multilayer structure body according to the fifth embodiment of the present invention together with the change in its atomic mass number.

FIG. 17. is a diagram showing the change of the isotopic ratio of the natural Sr, which is added as a material that undergoes nuclide transmutation, together with the change in its mass number.

FIG. 18 is a diagram explaining the principle of the nuclide transmutation according to the second embodiment of the present invention.

FIG. 19 shows a structure of the nuclide transmutation device according to the second embodiment of the present invention.

FIG. 20 is a drawing showing the surface on the electrolyte cell side of the multilayer structure body after experiments using the nuclide transmutation device shown in FIG. 19.

FIG. 21 is a graph showing the results of SIMS analysis of the surface of the multilayer structure body after experiments using the nuclide transmutation device shown in FIG. 19.

FIG. 22 shows a structure of a nuclide transmutation device according the third embodiment of the present invention.

### DETAILED DESCRIPTION OF THE INVENTION

Below, the nuclide transmutation device and nuclide transformation method according to the first embodiment of the present invention are explained referring to the figures.

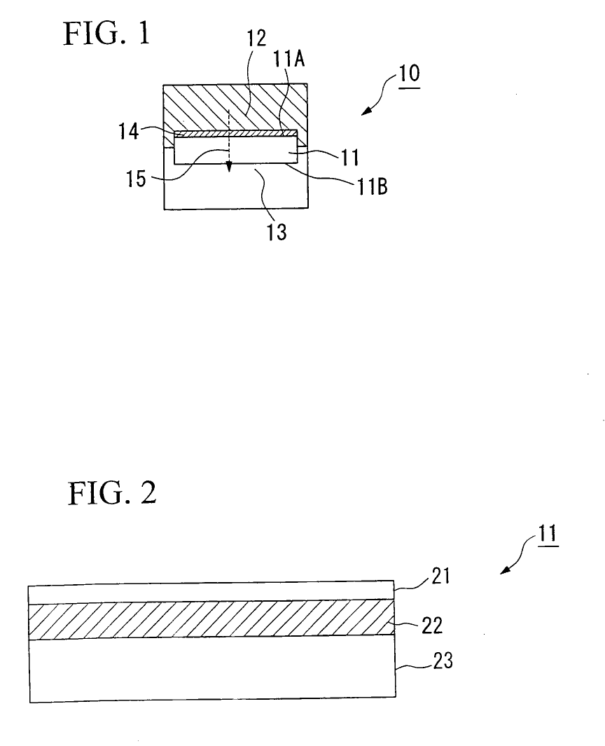

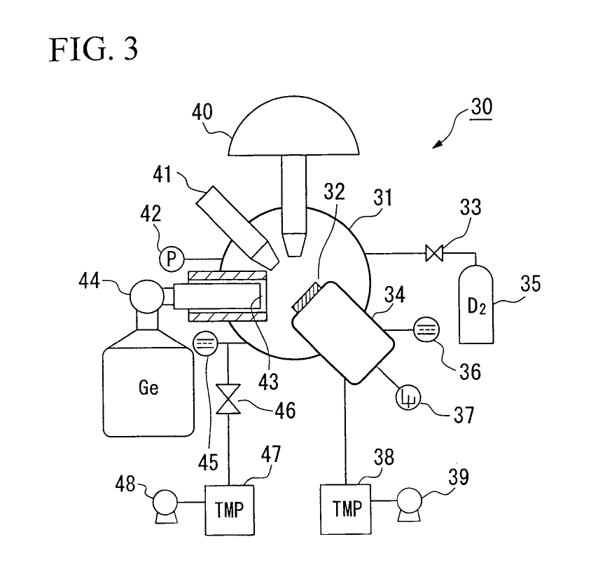

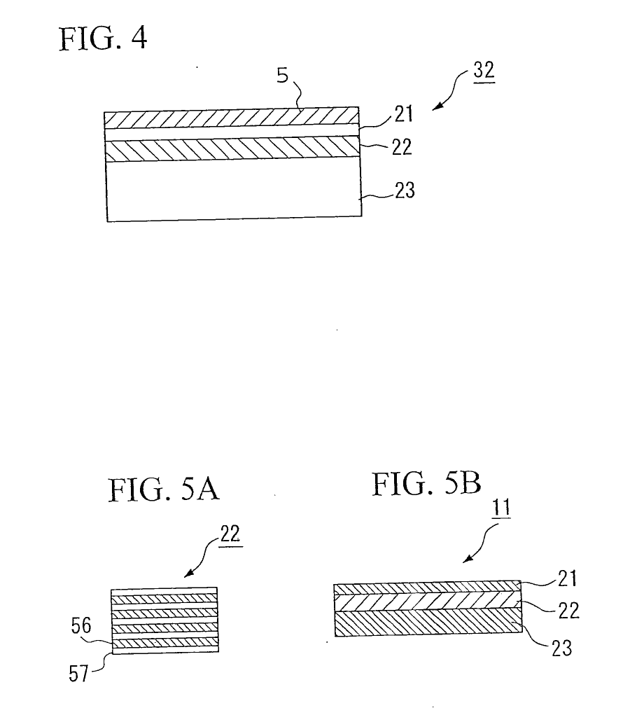

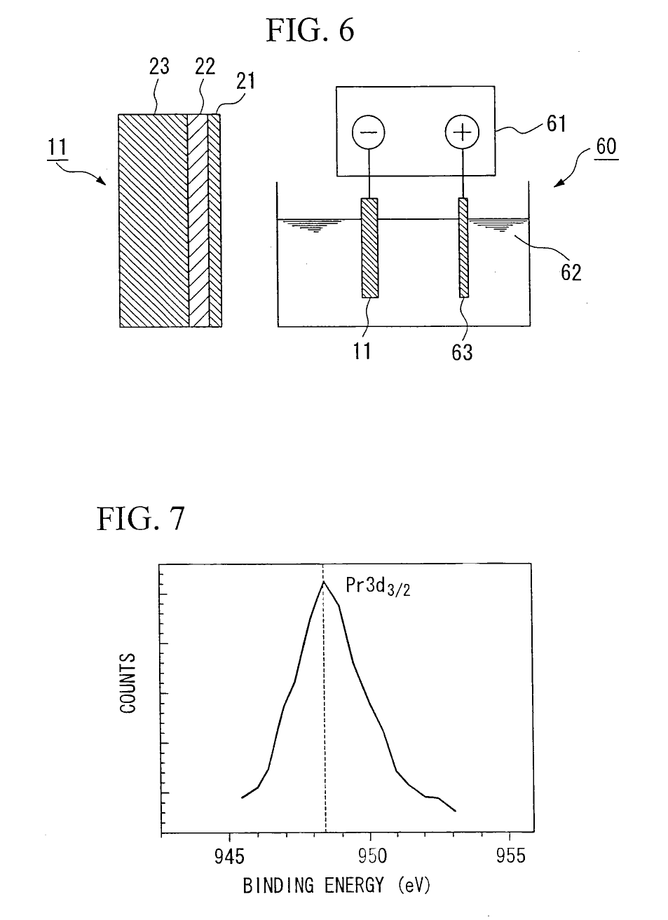

FIG. 1 is a drawing for explaining the principle of the nuclide transmutation method according to the first embodiment of the present invention; FIG. 2 is a cross-sectional structural drawing showing the structure body 1 used in the nuclide transmutation method according to the first embodiment of the present invention; FIG. 3 is a structural diagram of the nuclide transmutation device 30 according to the first embodiment of the present invention; FIG. 4 is s cross-sectional structure drawing of the structure body 51 used in the nuclide transmutation device shown in FIG. 3; FIG. 5A is a cross-sectional structural drawing of a mixed layer 22 and FIG. 5B is a cross-sectional drawing of the structure body 11 containing the mixed layer 22; FIG. 6 is a diagram of the device that adds a material, that undergoes nuclide transmutation, to the structure body 11.

As shown, for example, in FIG. 1, the device 10 that realizes the nuclide transmutation method according to the present embodiment comprises a structure body 11 having a substantially plate shape comprising palladium (Pd) or an alloy of Pd or another metal (for example, Ti) that absorbs hydrogen, or an alloy thereof, and a material that undergoes nuclide transmutation attached to one surface 11A among the two the surfaces of this structure body 11; and in the device a flow 15 of deuterium is generated in the structure body 11 due to the one surface side 11A of the structure body 11 serving as a region 12 in which, for example, a load or the pressure of hydrogen due to electrolysis is high and the other surface 11B side serving as a region 13 in which the pressure of the deuterium due to vacuum exhaust and the like is low; and the nuclide transmutation is carried out by the reaction between the deuterium and the material 14 that undergoes nuclide transmutation.

Here, as shown for example in FIG. 2, the structure body 11 is preferably formed by a mixed layer 22 of a material that has a relatively low work function, that is, a material that emits electrons easily (for example, a material having a work function equal to or less than 3 eV), and Pd being formed on the surface of a Pd substrate 23, and a Pd layer 21 being laminated on surface of the mixed layer 22.

As shown in FIG. 3, the nuclide transmutation device 30 according to the present embodiment comprises an absorption chamber 31 having an interior that can be maintained in an airtight state, a radiation chamber 34 provided inside this absorption chamber 31 that can be maintained airtight due to the multilayer structure body 32, a deuterium tank 35 that supplies deuterium into the absorption chamber 31 via the variable leak pump 33, a radiation chamber vacuum gauge 36 that detects the degree of the vacuum in the radiation chamber 34, a substance analyzer 37 that detects the gaseous reaction products produced, for example, from the multilayer structure body 32, and evaluates the amount of penetration of the deuterium that penetrates the multilayer structure body 32 by measuring the amount of deuterium in the radiation chamber 34, a turbo-molecular pump 38 that always maintains the interior of the radiation chamber 34 in a vacuum state, and a rotary pump 39 for preliminary evacuating the radiation chamber 34 and the turbo-molecular pump 38.

Further, the nuclide transmutation device 30 comprises static electricity analyzer 40 that detects photoelectrons, ions, and the like emitted from the atoms of the surface of the multilayer structure body 32 that are excited due to irradiation by X-rays, an electron beam, and a particle beam and the like, an X-ray gun 41 for XPS (X-ray Photo-electron Spectrometry) that radiates X-rays on one surface exposed to deuterium among the two surfaces of the multilayer structure body 32 in the absorption chamber 31 that is exposed to deuterium, a pressure meter 42 that detects pressure in the absorption chamber 31 into which deuterium has been introduced, an X-ray detector comprising, for example, a high purity germanium detector 44 having a beryllium window 43, an absorption chamber vacuum meter 45 that detects the degree of the vacuum in the absorption chamber 31, a vacuum valve that maintains the interior of the absorption chamber 31 is a vacuum state 46 before the introduction of the deuterium, for example, a turbo-molecular pump 47 that evacuates the absorption chamber 31 to a vacuum state, and a rotary pump 48 for preliminary evacuating the absorption chamber 31 and the turbo-molecular pump 47.

In addition, by placing the absorption chamber 31 side of the multilayer structure body 32 in a condition in which the pressure of the deuterium is relatively high placing the radiation chamber 34 side of the multilayer body 32 in a condition in which the pressure of the deuterium is relatively low, and forming the pressure difference in the deuterium on both surfaces of the multilayer structure body 32, a flow of deuterium from the absorption chamber 31 side to the radiation chamber 34 side is produced.

Here, as shown in FIG. 4, for example, the multilayer structure body 32 is formed such that a mixed layer 22 of a material that has a relatively low work function (for example, a material having a work function equal to or less than 3 eV) and Pd is formed on the surface of the Pd substrate 23, the Pd layer 21 is laminated on the surface of this mixed layer 22, and a cesium (Cs) layer 52 is added to the surface of the Pd layer 21 as the material that undergoes nuclide transmutation.

The nuclide transmutation device 30 according to the present embodiment is provided, and next, the method for carrying out the nuclide transmutation using this nuclide transmutation device 30 will be explained referring to the figures.

First, the Pd substrate 23 (for example, having a length of 25 mm, a width of 25 mm, a depth of 0.1 mm, and a purity of 99.5% or greater) shown in FIG. 2, for example, is degreased by ultrasound cleaning over a predetermined time interval in acetone. In addition, in a vacuum (for example, equal to or less than 1.33×10⁻⁵ Pa), annealing, that is, heat processing, is carried out over a predetermined time interval at 900° C. (step S01).

Next, at room temperature, contaminants are removed from the surface of the Pd substrate 23 after annealing by carrying out etching processing over a predetermined time interval (for example, 100 seconds) using heavy aqua regia (step S02).

Next, using a sputtering method employing an argon ion beam, the structure body 11 is produced by carrying out surface formation on the Pd substrate 23 after the etching processing. Here, for example, the thickness of the Pd layer 21 shown in FIG. 2 is 400×10⁻¹⁰ m, and the mixed layer 22 of the material having a low work function and the Pd, as shown in FIG. 5A, is formed by alternately laminating, for example, a CaO layer 57 having a thickness of 100×10⁻¹⁰ m and, or example, a Pd layer 56 having a thickness of 100×10⁻¹⁰, and thus the thickness of the mixed layer 22 is 1000×10⁻¹⁰. In addition, by forming as a film a Pd layer 21 on the surface of the mixed layer 22 of 400×10⁻¹°, the structure body 11 is formed (step S03).

Next, by electrolysis of CsNO₃ of a dilute solution of D₂O (a solution of CsNO₃/D₂O), as an example that undergoes nuclide transmutation, for example, the material Cs is added to the film processed surface of the structure body 11. For example, like the electrodeposition device 60 shown in FIG. 6 using 1 mM of a CsNO₃/D₂O solution as the electrolyte 62, connecting the platinum electrode 63 to the anode of the power source 61, connecting the structure body 11 to the cathode, and carrying out electrolysis over a 10 second interval at a voltage of 1V, the reaction represented by the following chemical Formula (1) is produced, a Cs layer 52 is added, and the multilayer structure body 32 is formed (step S04).

Cs⁺+e⁻→Cs (1)

In addition, the Cs layer 52 of the multilayer body 32 is faced towards the absorption chamber 31 side, the absorption chamber 31 and the desorption chamber 34 are closed into an airtight state by interposing the multilayer structure body 32. The desorption chamber 34 is evacuated first using a rotary pump 39 and a turbo molecular pump 38. Furthermore, the absorption chamber 31 is evacuated using the rotary pump 48 and the turbo molecular pump 47 by closing the variable leak valve 33 and by opening the vacuum valve 46 (step S05).

Next, after sufficiently stabilizing the degree of the vacuum of the absorption chamber 31 (for example, to be equal to or less than 1×10⁻¹⁵ Pa), the elements present on the surface of the multilayer structure body 32 on the absorption chamber 31 side are analyzed by XPS (step S06). That is, the surface of the multilayer structure body 32 is irradiated by an X-ray beam from an X-ray gun 41, and energy of the photoelectrons emitted from atoms on the surface of the multilayer structure body 32 excited by the X-ray irradiation is analyzed by the electrostatic analyzer 40 so that the elements present on the absorption chamber 31 side surface of the multiplayer structure body 32 are identified.

Next, after heating the multilayer structure body 32 by a heating device (not shown), for example, to 70° C., the vacuum exhausting of the absorption chamber 31 is suspended by closing the vacuum valve 46, a deuterium gas is introduced at a predetermined gas pressure into the absorption chamber 31 by opening the variable leak valve 33, and the experiment on nuclide transmutation is commenced. Here, the gas pressure when deuterium is introduced into the absorption chamber 31 is, for example, 1.01325×10⁵ Pa (or 1 atmosphere).

In addition, measurement of the gaseous reaction product (for example, the mass number A=1 to 140) is carried out using the mass spectrograph 37 in the radiation chamber 34, and the diffusion behavior of the deuterium that penetrates through the multilayer structure body 32 and is radiated into the radiation chamber 34 is evaluated. In addition, measurement of the X-ray is carried out by a high purity germanium detector 44 disposed on the absorption chamber 31 side of the multilayer structure body 32 (step S07).

Note that the amount of deuterium released into the desorption chamber 34 after permeating through the multilayer structure body 32 is calculated based on the degree of vacuum in the desorption chamber 34 detected by a desorption chamber vacuum gauge 36 and a volume flow rate of a turbo molecular pump 38.

After the commencement of the introduction of the deuterium gas into the absorption chamber 31, for example, after several tens of hours, the temperature of the multilayer structure body 32 is restored to room temperature. The introduction of the deuterium gas is suspended by closing the variable leak valve 33, and furthermore, the absorption chamber 31 is evacuated by opening the vacuum valve 46 and the experiment on nuclide transmutation is ended.

In addition, after sufficiently stabilizing the degree of the vacuum in the absorption chamber 31 (for example, equal to or less than 1×10⁻⁵ Ps), the elements present on the surface of the multilayer structure body 32 on the absorption chamber 31 side is analyzed by XPS, and thereby the measurement of products is carried out (step S08).

In addition, the processing in the above-described steps S06 to S07 is repeated, and the change over time of the nuclide transmutation reaction is measured (step S09).

Additionally, the multilayer structure body 32 is extracted from the nuclide transmutation device 30, and the experiment on the nuclide transmutation is ended (step S10).

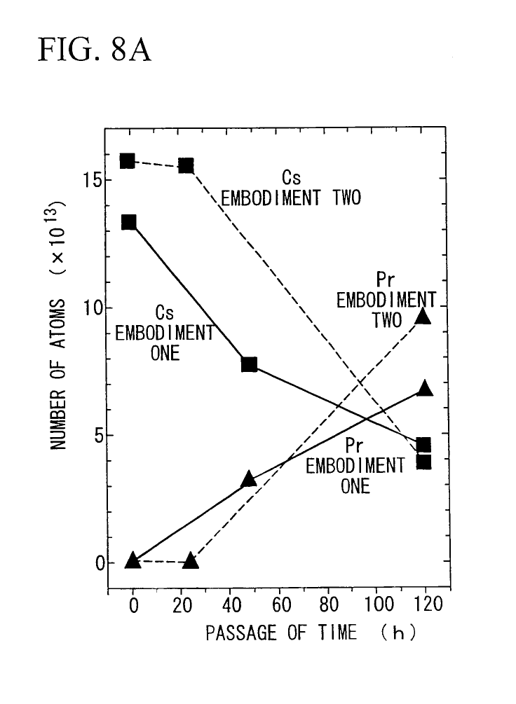

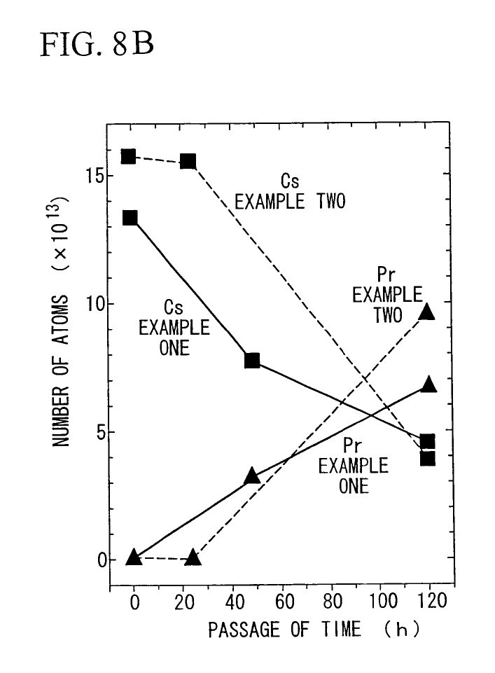

Below, the results of the two experiments on nuclide transmutation carried out using the nuclide transmutation method according to the present embodiment, that is, the example 1 and example 2 when the identical experiment is carried out two times, will be explained referring to FIG. 7 and FIG. 8.

FIG. 7 is a graph showing the spectrum of Pr using XPS in the surface of the multilayer structure body 32 shown in FIG. 4, and FIG. 8 is a graph showing the change over time in the number of atoms of Cs and Pr in the surface of the multilayer structure body 32 shown in FIG. 4.

According to the results of the XPS analysis of the example one and example two, in the example one and the example two the Cs (atomic number Z=55) of the multilayer structure body 32 decreases with the passage of time, and for example, like the spectrum of Pr using XPS shown in FIG. 7, the Pr (praseodymium, atomic number Z=59) increased.

Below, the method of calculating the number of atoms of each element from the spectrum of Cs and Pr using XPS will be explained.

Moreover, the strength of X-rays radiated from the X-ray gun 41 to the multilayer structure body 32 during the measurement by XPS is made constant, and the region in which these X-rays are desorbed is assumed to be identical in each of the measurements of the example one and the example two.

Furthermore, the region in which the X-rays are emitted on the surface of the multilayer structure body 32 is, for example, a circular region having a diameter of 5 mm, and from the estimation of the escape depth of the photoelectrons that are emitted, the depth that can be analyzed in XPS is, for example, 20×10⁻¹⁰.

In addition, the Pd that forms the Pd substrate 23 is an fcc (face-centered cubic) lattice, and thus the number of Pd atoms, calculated from the peak strength of the spectrum of PD obtained by XPS, is 3.0×10¹⁵.

In addition, the number of atoms of each element is calculated by comparing the peak strength of the spectrum of each element obtained by XPS and the peak strength of the spectrum of Pd, referring to the ratio of the ionization cross section of each element, that is, the electrons in the inner shell of the elements, that are excited due to absorbing X-rays and the like. Moreover, in Table 1, the calculated value of the ionization cross section of each element is shown as a relative value in the case that the value of the 1s orbital of C (2.22×10⁻²⁴ m²) is set to ‘1’. Further, in the following chart 1, 2p of Si, 2p of S, and 2p of C1 are calculated as the sum of 2p_{3/2} and 2p_{1/2}.

TABLE 1

| | ionization | | ionization |
|---|---|---|---|
| bonding energy of | cross | bonding energy of | cross |
| inner shell electrons | section | inner shell electrons | section |
| C 1s (283.5 eV) | 1.00 | Mg 2s (88.6 eV) | 2.27 |
| O 1s (543.1 eV) | 2.29 | Pd 3d_{5/2} (335.1 eV) | 10.1 |
| Si 2p (99 eV) (*) | 0.894 | Pd 3d_{3/2} (340.4 eV) | 7.03 |
| Si 2s (149.8 eV) | 0.884 | Cs 3d_{5/2} (726.6 eV) | 22.93 |
| S 2p (163 eV) (*) | 1.85 | Ce 3d_{5/2} (883.9 eV) | 28.57 |
| Cl 2p (201 eV) (*) | 2.47 | Pr 3d_{5/2} (928.8 eV) | 30.72 |

As shown in FIG. 8, in the first example, under initial conditions, 1.3×10¹⁴ atoms of Cs were reduced to 8×10¹³, and after 120 hours, were reduced to 5×10¹³.

In contrast, although Pr was not present before the commencement of the experiment, after 48 hours, 3×10¹³ atoms thereof, were detected, and after 12 hours, the number was observed to increase to 7×10¹³ atoms.

Similarly, in the second example as well, with the passage of time from the commencement of the experiment, a decrease in the number of Cs atoms and Pr production and an increase in the number of Pr atoms was observed, showing a tendency substantially identical to that of the first example. Thus, this can be interpreted as showing that the nuclide transmutation of Cs to Pr was occurring.

Moreover, in the following, we will consider whether or not the detected Pr is due to contaminants.

In the first example and the second example of the present embodiment as described above, analysis of elements was carried out without extracting the multilayer structure body 32 from the vacuum container comprising the absorption chamber 31 and the radiation chamber 34, and thus the causes of the introduction of contaminants that can be considered are contaminants included on the deuterium gas (D₂ gas) and contaminants in the multilayer structure body 32.

In the case of analyzing D₂ gas in the nuclide transmutation device 30 when the D₂ gas is 99.6% pure, and the contaminant N₂ and D₂O are equal to or less than 10 ppm, contaminants O₂, CO₂, and CO are equal to or less than 5 ppm, gases of contaminants other than these contaminants and hydrocarbons were not detected.

In contrast, in the multilayer structure body 32, the purity of the Pd was 99.5%, and the purities of CaO and CsNO₃ were 99.9%. In addition, as a result of carrying out quantitative analysis of lanthanides (₅₇La to ₇₁Lu) in the multilayer structure body 32 before the commencement of the experiment using glow desorption mass spectrometry (GD-MS), Nd was detected at 0.02 ppm, and the other lanthanides besides Nd were below detection limits, that is, equal to or less than 0.01 ppm.

Here, if we assume that 0.01 ppm of Pr, which is the detection limit, is present in the multilayer structure body 32 used in the first example and the second example (for example, 0.7 g≈7×10⁻³ mol), then the number of Pr atoms present in the multilayer structure body 32 would be 4.2×10¹³.

In this case, based on the above assumption, if we assume that the Pr atoms detected in example 1 and example 2 are Pr atoms below the detection limits, then it is also necessary to assume that all the Pr atoms below the detection limit are disposed so as to be concentrated in the region having a depth of several 10×10⁻¹⁰ m from the surface of the multilayer structure body 32, and a physical phenomenon in which the Pr atoms scattered as contaminants in the multilayer structure body 32 are concentrated only in proximity to the surface of the multilayer structure body 32 is thermodynamically impossible. Thus, we cannot conclude that the Pr atoms detected in example one and example two are contaminants included beforehand in the multilayer structure body 32. Furthermore, if they are impurities included beforehand in the multilayer structure body 32, we can determine that there is no time dependent change of the atomic number, that is, a change over time in the number of atoms will maintain a constant value.

Based on the above, we can conclude that the Pr detected in example one and example two is produced as a result of the nuclide transmutation reaction.

Moreover, the experimental results of the above-described example one and example two are extremely well explained by the EINR model that appeared in the journal Fusion Technology, published by the US Atomic Energy Conference (Y. Iwamura, T. Itoh, N. Gotoh, and I. Toyoda, “Detection of Anomalous Elements, X-ray, and Excess Heat in a D₂-Pd System and its Interpretation by the Electron-Induced Nuclear Reaction (EINR) Model”, Fusion Technology, vol. 33, no. 4, p. 476, 1998).

According to this EINR model, we can consider the Pr to be produced from Cs according to the Formula (1) and Formula (2).

Moreover, in the following Formula (1) and Formula (2), d denotes deuterium, e denotes electrons, ₂n denotes dineutrons, and v denotes neutrinos.

₁²d+₋⁰e→₀²n+v (2)

₅₅¹³³Cs+4₀²n→₅₉¹⁴¹Pr (3)

As shown in Formula (2), according to the EINR model, deuterium captures electrons to generate dineutrons, and simultaneously, nuclide transmutation occurs due to reacting with substances such as Cs. Moreover, in Formula (3), the symbols for β decay, that is, the β⁻ decay from ¹⁴¹Cs (=¹³³Cs+4²n) to ¹⁴¹Pr, have been omitted.

As described above, according to the nuclide transmutation device 10 of the present embodiment, a relatively large-scale device such as a nuclear reactor or an accelerator are not necessary, and the process of nuclide transmutation can be implemented with a relatively small-scale construction.

In addition, according to the nuclide transmutation method of the present embodiment, the possibility that the number of atoms of Pr, which are not detected before the commencement of the experiment and are detected to be increasing after the commencement of the nuclide transmutation experiments, are detected due to contaminants included beforehand in the supplied D₂ gas or in the multilayer structure body 32 is eliminated, and the production of a nuclide transmutation reaction from Cs to Pr can be repeated well and reliably.

Moreover, in the embodiment described above, the multilayer structure body 32 was formed by adding a cesium (Cs) layer 52 to the surface of the Pd layer 21 as a material that undergoes the nuclide transmutation, but the invention is not limited thereby, and in place of using Cs as a material that undergoes the nuclide transmutation, other materials such as carbon (C) can be added.

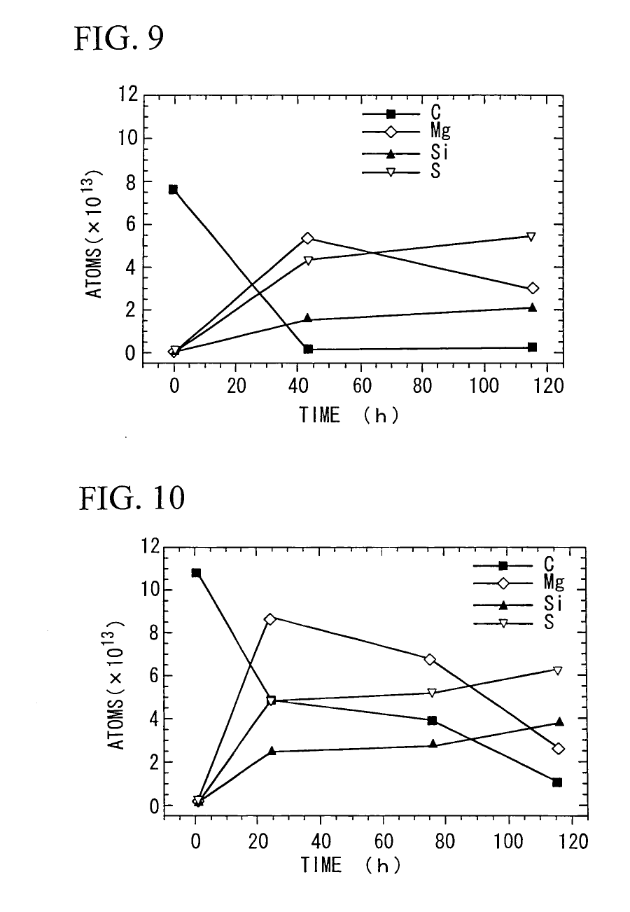

Below, as a first modified example of the present embodiment, the case of adding carbon (C), for example, as a material that undergoes the nuclide transmutation on the surface of the Pd surface 21, will be explained referring to FIG. 9 and FIG. 10.

FIG. 9 is a graph showing the change in the number of atoms for each of C, Mg, Si, and S over time on the surface of the multilayer structure body 32 in the third example, and FIG. 10 is a graph showing the change in the number of atoms for each of C, Mg, Si, and S over time on the surface of the multilayer structure body 32 in the fourth example.

In this first modified example, the point that differs greatly from the first embodiment described above is the method of forming the multilayer structure body 32, and in particular, the process in step S04 described above.

Specifically, after the step S03 described above, the multilayer structure body 32 is formed by carbon (C) in the atmosphere adhering to the surface of the Pd layer 21 due to exposing the structure body 11 comprising the Pd substrate 23, mixed layer 22, and the Pd layer 21 to the atmosphere (step S14).

In addition, the Pd layer 21 having the adhering C is faced towards the absorption chamber 31, the absorption chamber 31 and the radiation chamber 34 are closed by interposing the multilayer structure body 32 therebetween, and a vacuum desorption is respectively carried out on both the absorption chamber 31 and the radiation chamber 34.

Then the processing in the following the above-described step S06 is carried out.

Below, the results of two experiments, that is, the example three and example four when the same experiment according to the first modified example is carried out two times, on nuclide transmutation experiment carried out by the nuclide transmutation method of the modified example of the present embodiment is explained referring to the figures.

In this case, by the results of the analysis of CPS in example 3 and example 4, in example 3 and example 4, the C in the multilayer structure body 32 decreases with the passage of time, and Si and S, which are reaction products, and Mg, which is an intermediate product, were detected.

In addition, similar to the embodiment described above, the number of atoms of each element is calculated from the spectrum of C, Mg, Si, and S by XPS.

As shown in FIG. 9, in example 3, the number of C atoms originating in hydrocarbons decreased 44 hours after the commencement of the experiment, while Mg, which was not present before the commencement of the experiment, was detected 44 hours later, and furthermore, had somewhat decreased after 116 hours.

Furthermore, Si and S, which were not present before commencement of the experiment, increased monotonically 44 hours later and 116 hours later.

As shown in FIG. 10, in example 4, the number of C atoms originating in hydrocarbons decreased monotonically 24 hours, 76 hours, and 116 hours after the commencement of the experiment, while in contrast Mg, which was not present before the commencement of the experiment, was produced 24 hours after commencement, and furthermore, monotonically decreased after 76 and 116 hours.

Furthermore, Si and S, which were not present before commencement of the experiment, monotonically increased 24, 76, and 116 hours after commencement.

According to the above results, the nuclide transmutation method according to the modified example of the present invention resulted in C being transmuted, and Mg, Si, and S being generated.

In this case, according to the EINR model described above, the nuclide transmutation of C is represented in Formula (2) described above and Formula (4). Moreover, in Formula 4, a reaction by a dineutron cluster (6²n, 2²n) is represented.

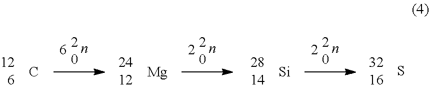

Below, the second modified example of the present embodiment is explained with reference to FIGS. 11 to 17 when, for example, strontium (Sr) is added on the surface of the Pd layer 21 as an element that undergoes nuclide transmutation.

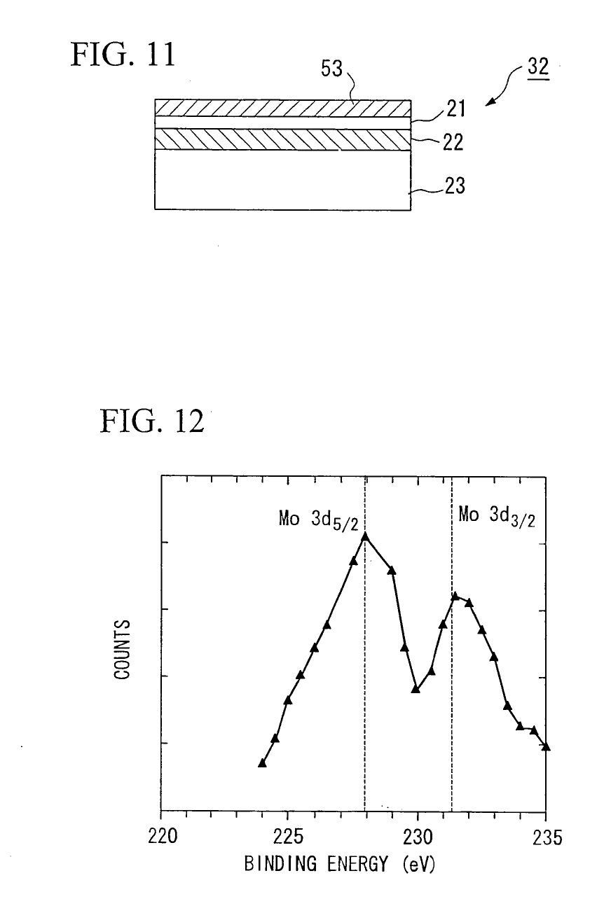

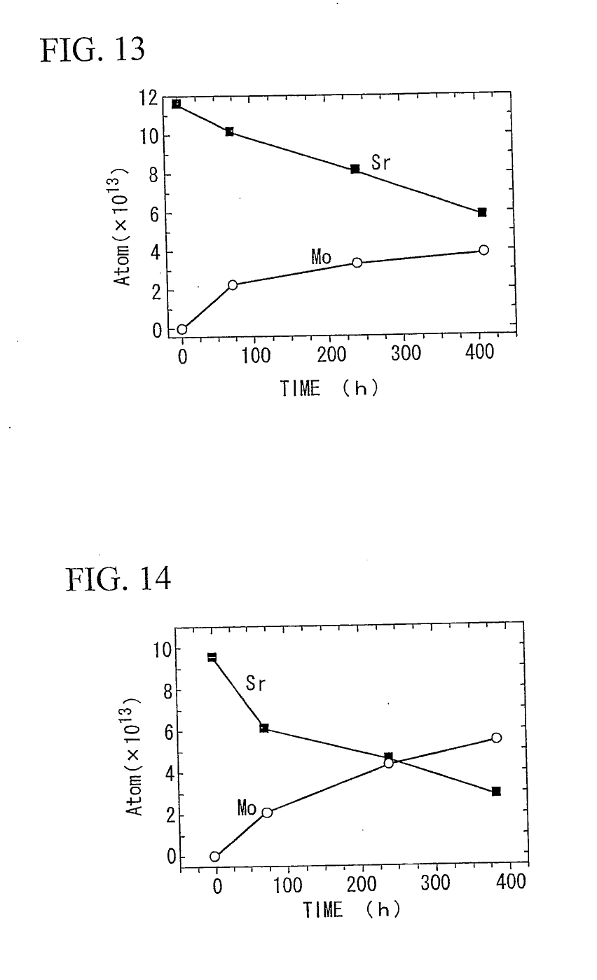

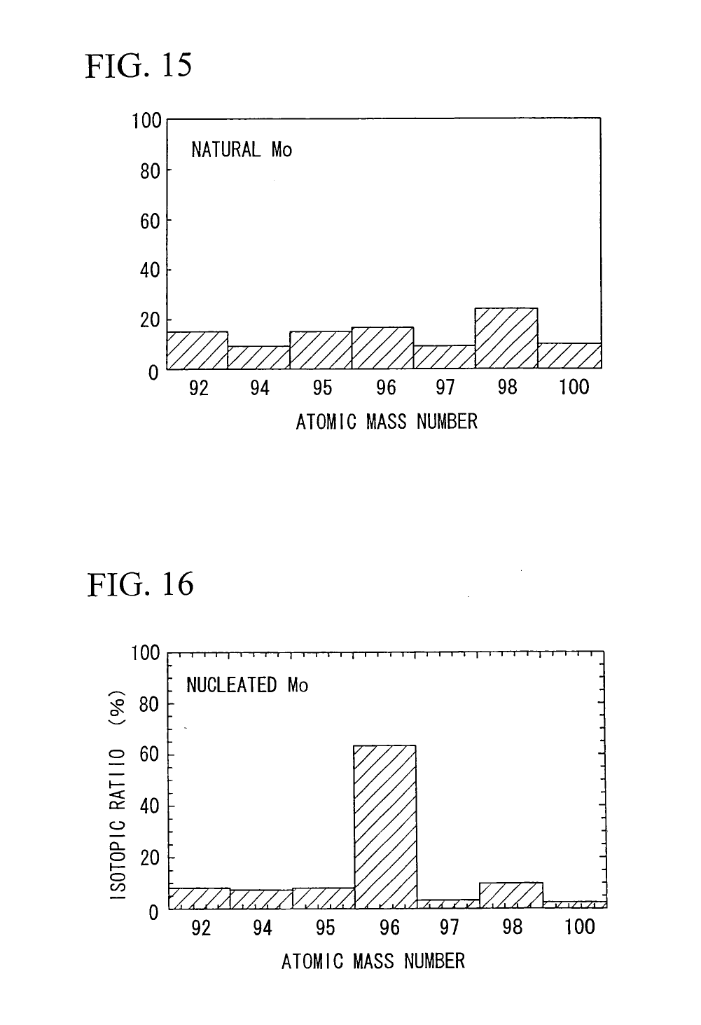

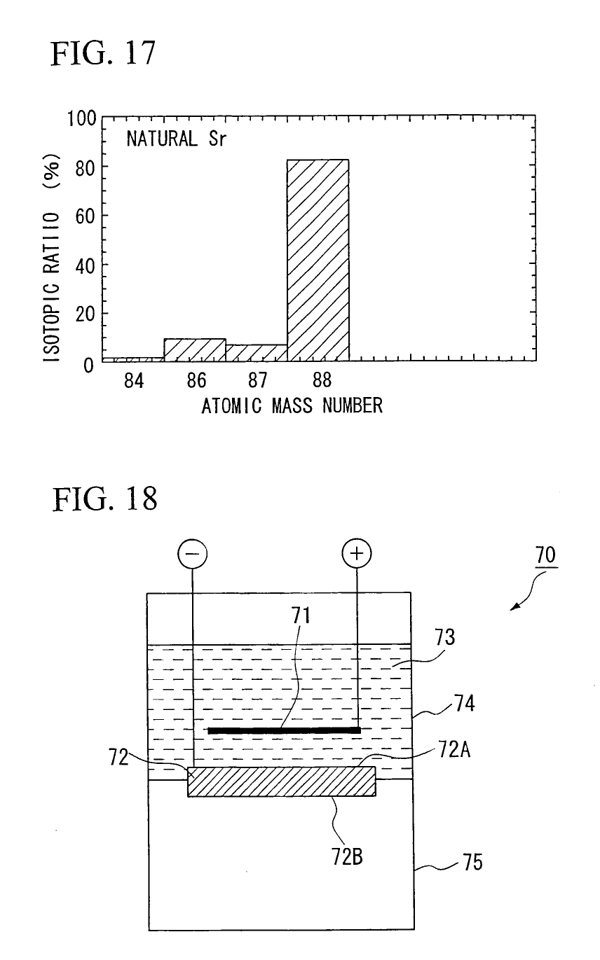

FIG. 11 is a cross-sectional structure diagram showing the multilayer structure body 32 related to the second modified example of the present embodiment. FIG. 12 is a graph showing the XPS spectrum of the Mo element on the surface of the multilayer structure body 32 shown in FIG. 11. FIGS. 13 and 14 show a time dependent change of atomic numbers of respective Sr and Mo elements on the surface of the multilayer structure body 32. FIG. 15 shows the change of a isotopic ratio and the atomic mass number of natural Mo. FIG. 16 shows the change of an isotopic ratio and the atomic number of Mo observed on the multilayer structure body 32 in the fifth embodiment. FIG. 17 is a graph showing the change of the isotopic ratio and the atomic mass number of the natural Sr added as a material that undergoes nuclide transmutation.

In this second modified example, the Sr layer 53 is added on the multilayer structure body 32 in place of the Cs layer 52 used for being subjected to the nuclide transmutation. That is, the point of the second modified example which differs from the above-described first modified example is the method of forming the multilayer structure body 32, particularly, the processing in step S04. Note that, in the second modified example, the Pd substrate 23 has a size of 25 mm×25 mm×0.1 mm (length×width×thickness) and having a impurity of more than 99.9%.

In the second modified example, after the above-described step S03, Sr, for example, is added as the material that undergoes nuclide transmutation on the film formed surface of the structure body by electrolysis of a diluted solution of SrO in D₂O (Sr(OD)₂/D₂O solution) on the film forming surface of the multiplayer structure body 11. In the electrodeposition device 60, for example, shown in FIG. 6, 1 mM of the Sr(OD)₂/D₂O solution is used, and electrolysis is carried out, for example, for 10 seconds at 1V after connecting the anode of the power source 61 to the platinum anode 63 and connecting the cathode of the power source 61 to the multilayer structure body 11. The chemical reaction shown by the formula (5) takes place by the electrolysis, and the Sr layer 53 is deposited on the surface of the multilayer structure body 32 (step S04a)

Sr²⁺+2e⁻→Sr (5)

Subsequently, the Sr layer 53 of the multilayer structure body 53 is directed to the absorption chamber 31 and the processes below step S05 are conducted.

Hereinafter, two results of the nuclide transmutation experiments, that is, the results of the example 5 and example 6, which were conducted by repeating the same experiment for two times in line with the nuclide transmutation method according to the second modified example of the present embodiment are described.

The analysis of XPS obtained in the example 5 and example 6 indicated that Sr (the atomic number Z=38) on the multilayer structure body 32 has been decreased with the passage of time, and Mo (molybdenum, Z=42) has been increased as shown by the Mo spectrum of XPS in FIG. 12.

The calculation of the number of atoms of Sr and Mo from the XPS spectrum of Sr and Mo are conducted by the same method as that in the first embodiment.

That is, it is assumed that the intensity of the X-ray irradiated on the multilayer structure body 32 from the X-ray gun during XPs measurement is constant and that the regions irradiated by X-ray for the measurements in example 5 and example 6 are the same.

Furthermore, it is also assumed that the region on the multilayer structure body 32 irradiated by X-rays is, for example, a circle with a diameter of 5 mm and that the measurable surface thickness by XPS is 20×10⁻¹⁰ m from the estimation of the depth of the photoelectrons escaped from the surface.

The number of atoms of Pd is assumed to be 3×10¹⁵ based on the peak intensity of the Pd spectrum obtained by XPS, assuming that the Pd constituting the Pd substrate is composed of a face centered cubic (fcc) crystal.

The number of atoms of each elements is calculated by comparison of the peak intensity of each element with the peak intensity of the Pd spectrum obtained by XPS, with reference to the ionization cross section of each element, that is, the ratio of inner-shell electrons excited by absorbing X-rays.

As shown in FIG. 13, it has been observed that, in example 5, the number of atoms of 1.2×10¹⁴ of Sr present at the initial condition is reduced to 1.0×10¹⁴ after 80 hours, and further reduced to 8×10¹³ after 400 hours.

In contrast, it was observed that 2.2×10¹³ atoms of Mo, which were not present before starting the experiment, were observed after 80 hours, and the number of atoms of Mo was increased to 3.2×10¹³ after 240 hours, and was further increased to 3.8×10¹³ after 400 hours.

Similarly, in experiment 6 shown in FIG. 14, the same tendency as the case of example 5 was observed. That is, the number of Sr atoms is reduced with the passage of time, and generation and an increase of number of Mo atoms, which is not present at the initial condition, are observed.

Furthermore, in both examples 5 and 6, since the time dependent reduction number of Sr atoms approximately conforms with the time dependent increasing number of Mo atoms, this tendency is interpreted to mean that the nuclide transmutation occurs from Sr to Mo. Consequently, it is possible to mention that the experiments in both examples 5 and 6 yield reproducible results.

In addition, in example 5, the isotopic ratio of Mo generated by the experiment is calculated through an analysis of the surface of the multilayer structure body 32 using SIMS (Secondary Ion Mass Spectroscopy) after the above-described step S10.

As shown in FIG. 16, the isotopic ratio of Mo observed in example 5 when compared to that of the isotopic ratio of the natural Mo indicates that a particular isotope of Mo, that is, ⁹⁶Mo, shows a dramatically high abundance ratio.

As shown in FIG. 17, the isotopic ratio of the natural Sr added to the multilayer structure body 32 indicated that a particular isotope of Sr, that is, ⁸⁸Sr, shows a remarkably high abundance ratio. The above results clearly indicate that there is a strong correlation between the isotopic ratio of a nuclide (Sr) that undergoes nuclide transmutation and the isotopic ratio of the material (Mo) observed after the experiment, so that it can be concluded that the Mo detected in examples 5 and 6 is generated by the nuclide transmutation of Sr.

Furthermore, the experimental results of examples 5 and 6 are quite well explainable by the above-mentioned EINR model, and it is possible to explain that ⁹⁶Mo is formed by the reaction shown in equations (2) and (6), which is described later.

Note that the letter symbol of β⁻ decay, that is, the decay of ⁹⁶Sr (=⁸⁸Sr+4²n) towards ⁹⁶Mo, is omitted.

₃₈⁸⁸Sr+4₀²n→₄₂⁹⁶Mo (6)

Below, the nuclide transmutation device and nuclide transmutation method according to the second embodiment of the present invention will be explained referring to the figures.

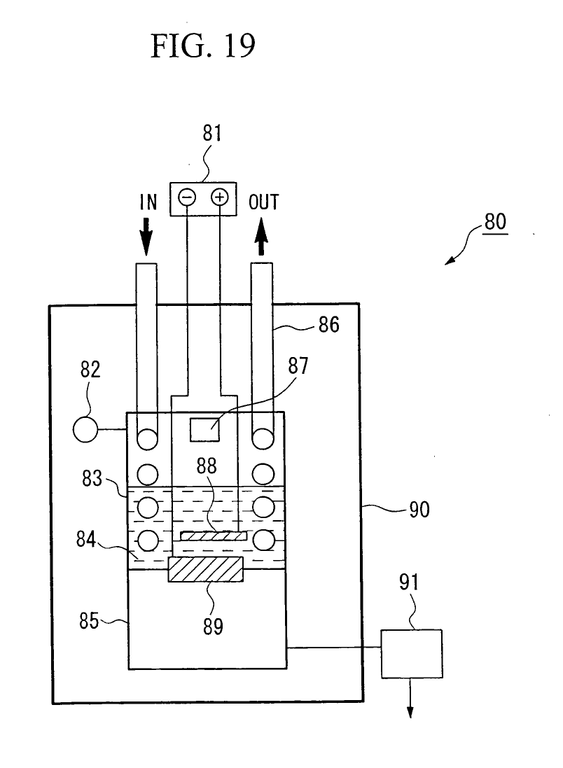

FIG. 18 is a drawing for explaining the principle of the nuclide transmutation method according to the second embodiment of the present invention. FIG. 19 is a structural diagram of the nuclide transmutation device according to the second embodiment of the present invention.

As shown, for example, in FIG. 18, the device 70 for realizing the nuclide transmutation method according to the present embodiment comprises an anode 71 of platinum and the like, a cathode 72 comprising palladium (Pd) or a Pd alloy, or another metal that can absorb hydrogen (for example, Ti and the like), or an alloy thereof, a heavy water solution 73 into which the cathode 71 and one surface of the cathode 72 are immersed, an electrolyte cell 74 made fluid-tight by the cathode 72 and filled with the heavy water solution that includes material that undergoes the nuclide transmutation, and a vacuum container 75 sealed air-tight by the anode 72, and wherein a flow of deuterium is generated in the cathode 72 by one surface 72A side of the cathode 72 being made a region having a high deuterium pressure due to electrolysis and the like, and the other surface 72B side being made a region having a low deuterium pressure due to vacuum evacuation and the like, and the nuclide transmutation is carried out by a reaction between the deuterium and the material that undergoes nuclide transmutation.

Here, the cathode 72 has a structure identical, for example, to the structure body 11 shown in FIG. 2, and preferably, a mixed layer 22 of a material having a relatively low work function, that is, a material that emits electrons easily (for example, a substance having a work function less than 3 eV), and Pd is formed on the surface of the Pd substrate 23, and the Pd layer 21 is formed by lamination on the surface of this mixed layer 22.

As shown in FIG. 19, the nuclide transmutation device 80 according to the present embodiment comprises a power source 81, an electrolytic cell 83 providing a voltmeter 82, an electrolytic solution 84 stored in the electrolyte cell 83, a vacuum container 85, a spiral refrigerating tube 86 made, for example, of an insulating resin that freezes the electrolytic solution 84 in the electrolyte cell 86, a catalyst 87, an anode electrode 88 of platinum and the like that is connected to the anode of the power source 81 and is immersed in the electrolytic solution 84, a multilayer structure body 89 that maintains the electrolyte cell 83 in a liquid-tight condition and at the same time maintains the vacuum container 85 in an air-tight state and is connected to the cathode of the power source 81, a thermostat 90 that accommodates the electrolyte cell 83 and the vacuum container 85 and controls the temperature, and a vacuum exhaust pump 91 that places the vacuum container 85 in a vacuum state.

Here, the electrolyte cell 83 made, for example, of an insulating resin and the vacuum container 85 made, for example, of stainless steel, are sealed in liquid-tight and air-tight states by the multilayer structure body 89 via, for example, a Culret's O-ring, and so to speak, connected via the multilayer structure body 89.

In addition, the electrolyte solution 84 stored in the electrolyte cell 83 is a heavy water solution that includes, for example, cesium (Cs) as a material that undergoes nuclide transmutation. This electrolyte solution 84 may be a Cs₂(SO₄) heavy water solution having a concentration, for example, of 3.1 mol/L.

Moreover, the catalyst 87 is formed by electrodepositing platinum black on platinum, water is produced from most of the hydrogen and oxygen generated by the electrolysis of the electrolytic solution 84, and this is returned to the electrolyte solution 84.

The nuclide transmutation device according to the present embodiment provides the structure described above, and next the method of carrying out nuclide transmutation using this nuclide transmutation device 80 will be explained referring to the figures.

First, the structure body 11 is produced in a manner identical to the step S01 to step S03 in the nuclide transmutation method in the above-described first embodiment.

In addition, this structure body 11 serves as the multilayer structure body 89, the Pd layer 12 of the multilayer structure body 89 is faced towards the electrolytic cell 83 side, and the electrolytic cell 83 and the vacuum container 85 are sealed in respectively liquid-tight and air-tight states (step S21).

Next, a Cs₂(SO₄) heavy water solution having a concentration, for example, of 3.1 mol/L is injected as an electrolytic solution 84 in the electrolytic cell 83. Furthermore, the space in the electrolytic cell 83 not filled by the electrolytic solution 84 is filled with nitrogen gas and sealed, and the pressure in the electrolytic cell 83 is maintained at, for example, 1.5 kg/cm² (step S22).

In addition, the vacuum container 85 is evacuated by a vacuum pump 91, and maintained in a vacuum state (step S23).

Additionally, a refrigerant is supplied to a refrigerant pipe 86 made of an insulating resin and the like, and the temperature in the electrolytic cell 83 is maintained at a predetermined constant temperature (step S24).

In addition, an anode electrode 88 made, for example, of platinum, and the multilayer structure body 89 serving as the cathode, which are immersed in the electrolytic solution 84 in the electrolytic cell 83, are connected to the power source 81, and the electrolytic reaction is generated by the power supplied from the power source 81 (step S 25).

Here, the current supplied during the electrolysis is gradually raised from 1 A to 2 A over a three hour interval, and subsequently maintained at 2 A.

In addition, after commencement of the electrolysis, the temperature of the thermostat 90 is set to 70° C. after 12 hours, and the temperature is thereafter maintained at this temperature (step S26).

This electrolysis is suspended after a predetermined time interval, for example, 7 days, and the temperature of the thermostat 90 is set to room temperature (step S27).

In addition, the multilayer structure body 89 is extracted from the nuclide transmutation device 80, and the surface of the multilayer structure body 89 is analyzed by secondary ion mass spectroscopy (SIMS) (step S28).

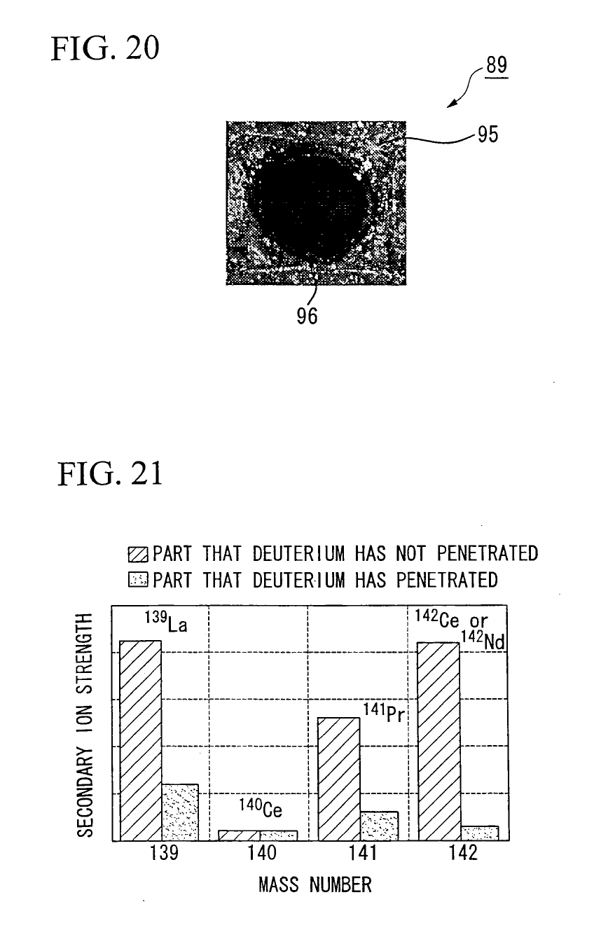

Below, the results of experiments using the nuclide transmutation experiment carried out using the nuclide transmutation method according to the present embodiment described above, that is, example seven, are explained referring to FIG. 20 and FIG. 21.

FIG. 20 is a drawing showing the surface on the electrolyte cell side of the multilayer structure body after experiments using the nuclide transmutation device shown in FIG. 19, and FIG. 21 is a graph showing the results of the SIMS analysis of the surface of the multilayer structure body after experiments using the nuclide transmutation device shown in FIG. 19.

With respect to the part 96 shown in FIG. 20 that the deuterium penetrates and the part 95 shown in FIG. 20 that the deuterium does not penetrate, as shown in FIG. 21, for ¹⁴⁰Ce the intensity of secondary ions agree, but for ¹³⁹La and ¹⁴¹Pr, the part not penetrated by the deuterium, that is, the part in which the nuclide transmutation reaction was produced, the intensity of the secondary ions became large.

In addition, although it is not possible to distinguish whether the mass number A=142 is ¹⁴²Ce or ¹⁴²Nd, the intensity of the secondary ions became large in the part 96 that the deuterium penetrated.

Thereby, it can be concluded that at least ¹⁴¹Pr is a substance formed by the nuclide transmutation of Cs.

As described above, according to the nuclide transmutation device 80 of the present embodiment, a relatively large-scale device such as a nuclear reactor or accelerator are unnecessary, and the nuclide transmutation process can be carried out with a relatively small-scale structure.

Furthermore, while the structure differs from the nuclide transmutation device 30 according to the first embodiment described above, experimental results were obtained showing that the nuclide transformation reaction from Cs to Pr is produced, and the effectiveness of the essential means of the present invention can be shown.

In addition, according to the nuclide transmutation method of the present embodiment, in the multilayer structure body 89, from a comparison of the part 96 that the deuterium penetrated and the part 95 that the deuterium did not penetrate, it can be reliably shown that at least a nuclide transmutation reaction from Cs to Pr is produced.

Moreover, in the present embodiment, a heavy water solution that includes a material that undergoes the nuclide transmutation was used as the electrolyte solution 84, but the invention is not limited thereby, and on one surface of the multilayer structure body 89, a substance that undergoes nuclide transmutation, for example Cs can be laminated by a film formation process such as vacuum deposition or sputtering, and the surface on which this Cs is laminated is faced towards the electrolytic cell 83, and immersed in an electrolytic solution 84 comprising the heavy water solution stored in the electrolytic cell 83. In this case, including a substance, for example, Cs, that undergoes nuclide transmutation in the heavy water solution is not necessary.

Moreover, in the present embodiment described above, the heavy water solution that includes Cs as the electrolyte solution 84 is used, but the invention is not limited thereby, and instead of Cs, another material such as sodium (Na) can be added as the material that undergoes the nuclide transformation.

Below, as a modified example of the present embodiment, the case in which sodium (Na) is added to the heavy water solution as the material that undergoes the nuclide transmutation will be explained.

In this modified example, the major point of difference with the second embodiment described above is the processing from step S22 and subsequent steps, as described above.

Specifically, after the above-described step S21, only, for example, 400 ppm of sodium is added as the electrolyte solution 84 in the electrolyte cell 83, and LiOD heavy water solution having a concentration of 4.3 mol/L is injected.

Furthermore, the contents of the space not filled by the electrolyte solution 84 in the electrolyte cell 83 is filled with nitrogen gas and sealed, and the pressure in the electrolyte cell 83 is maintained at, for example, 1.5 kg/cm² (step S32).

In addition, the inside of the vacuum container 85 is evacuated by the vacuum pump 91, and is maintained in a vacuum state (step S33).

Additionally, a refrigerant is supplied into the refrigeration tube 86 made, for example, from an insulating resin, and the temperature in the electrolyte cell 83 is maintained at a predetermined constant temperature (step S34).

In addition, the anode electrode 88 that is made from platinum and the like and immersed in the electrolyte solution 84 in the electrolyte cell 83 and the multilayer structure body 89 serving as a cathode are connected to the power source 81, and an electrolytic reaction is produced due to the power supplied from the power source 81 (step S35).

Here, the current supplied during electrolysis is gradually raised over, for example, a six hour interval from 0.5 A to 2 A, and subsequently maintained at 2 A.

In addition, this electrolysis is suspended after a predetermined interval, for example, after continuing for 7 days, and the temperature of the thermostat 90 is set to room temperature (step S36).

Additionally, the multilayer structure body 89 is extracted from the nuclide transmutation device 80, and the surface of the multilayer structure body 89 is analyzed using electron probe microanalysis (EPMA) (step S 37).

Below, the experimental results of three nuclide transmutation experiments carried out using the nuclide transmutation method according to the modified examples of the second embodiment of the present invention described above, that is, example 8, example 9, and example 10, which are the same experiment carried out three times.

Moreover, in the following Table 2, for example 8, example 9, and example 10, the results of the analysis of the electrolyte solution 84 using inductive coupled plasma-Auger electron spectrometry (ICP-AES) are shown. Moreover, the results of analysis of the electrolyte solution 84 before the commencement of the experiments are shown as comparative examples.

TABLE 2

| | Comparison | Example | Example | Example | |
|---|---|---|---|---|---|
| | example | six | seven | eight | |
| Na | 430 | 25 | 16 | 56 | (ppm) |
| | 0.086 | 0.005 | 0.003 | 0.011 | (g) |
| | 2.3 × 10²¹ | 1.3 × 10²⁰ | 8.4 × 10¹⁹ | 2.9 × 10²⁰ | (Atoms) |
| Al | <1 | 410 | 420 | 310 | (ppm) |
| | <2 × 10⁻⁴ | 0.082 | 0.084 | 0.062 | (g) |
| | <2 × 10¹⁸ | 1.8 × 10²¹ | 1.9 × 10²¹ | 1.4 × 10²¹ | (Atoms) |

As shown in Table 2, in the electrolyte solution 84 before the commencement of the experiments, the Na was at 430 ppm, and Al was equal to or less than the detection limit of 1 ppm.

In contrast, after the nuclide transmutation experiment, the Na became several tens of ppm, a value being one order lower, and the Al had become several tens of a ppm. The change in the electrolyte solution 84 after the commencement of the experiment carried out only electrolysis by providing current from the power source 81, and other materials were not introduced from the outside.

In addition, regarding the number of atoms (Atom, in Table 2), it could be confirmed that the decreased number of Na atoms fell from 2.2×10²¹ to about 2.0×10²¹, and the increased amount of the Al substantially agreed with this.

This result is represented by the above Formula (2) and the following Formula (7) in the EINR model described above.

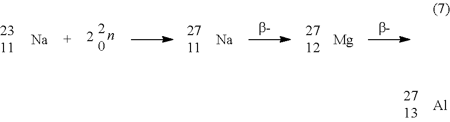

Here, for Na, the natural abundance of ²³Na is 100%, and for Al, the natural abundance of ²⁷Al is 100%. It can be inductively determined from past experimental data that nuclide transmutation is easily produced between nuclides having similar isotopic ratio compositions, and it can be inferred that the possibility that Na transmutes to Al is high since the isotopes that exists stably for both elements Na and Al are unique.

In addition, as a result of analysis of the multilayer structure body 89 using EPMA, Al was detected from the central part of the multilayer structure body 89, that is the part that the deuterium penetrated. Because Al is an amphoteric metal, it can be electrolyzed in the electrolytic solution 84, but by detecting Al from the center part of the surface of the multilayer structure body 89, we can conclude that Al was produced by the nuclide transmutation of Na.

Moreover, in the present embodiment, a heavy water electrolyte solution that includes a material that undergoes the nuclide transmutation is used, but the invention is not limited thereby, and on one of the surfaces of the multilayer structure body 89, a material that undergoes nuclide transmutation, for example, Na, can be laminated using a film formation method such as vacuum deposition or sputtering, the surface on which this Na has been laminated can be faced towards the inside of the electrolytic cell 83, and this can be immersed in the electrolytic solution 84 comprising the heavy water solution stored in the electrolyte cell 83. In this case, it is not necessary to include a material that undergoes the nuclide transmutation in the heavy water solution, that is, Na.

Below, the nuclide transmutation device and the nuclide transmutation method according to the third embodiment of the present invention are explained with reference to the attached drawings.

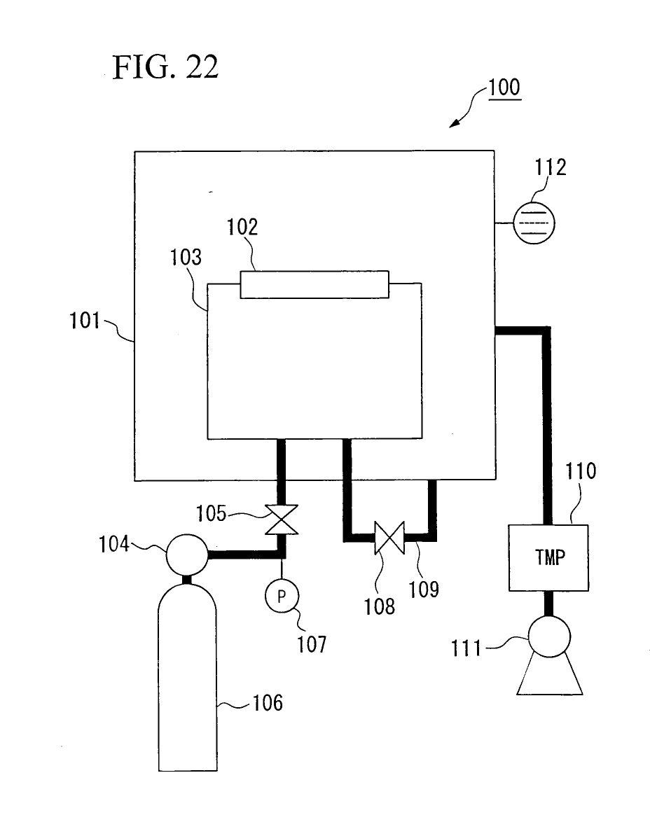

FIG. 22 shows a structure of the nuclide transmutation device 100 according to the third embodiment of the present invention.

The nuclide transmutation device 100 according to this embodiment comprises a desorption chamber 101 having an interior that can be maintained in an airtight state, an absorption chamber 103, disposed inside of the desorption chamber 101 and having an interior that can be maintained in an airtight state through a multilayer structure body 102, a deuterium tank 106 for supplying deuterium into the absorption chamber 103 through a regulator valve 104 and a valve 105, a pressure meter 107 for detecting the inside pressure of the absorption chamber 103, a connecting pipe 109 for connecting the desorption chamber 101 and a absorption chamber 103 through a vacuum valve 108, a turbo-molecular pump 110 for maintaining the inside of the desorption chamber 101, a rotary pump for preliminary evacuation of the desorption chamber 101, the absorption chamber 103, and the turbo-molecular pump 110, and a vacuum gauge 112 for detecting the degree of vacuum in the desorption chamber 101.

The nuclide transmutation method using the above-described nuclide transmutation device 100 according to this embodiment will be described below with reference to the attached drawings.

First, a platinum substrate 23 (for example, having a size of 70 mm in diameter and 0.1 mm in thickness and a purity of more than 99.9%) shown in, for example, FIG. 2, is degreased by ultrasonic cleaning in acetone over a predetermined time. Then, the substrate is heat treated, that is, annealed at a temperature of, for example, 900° C., in an argon atmosphere (step S42).

Subsequently, the platinum substrate 32, after the annealing process, is subjected to etching, for example, using a 1.5 times diluted aqua regia at room temperature for a predetermined time (for example, 100 seconds) to remove impurities on the substrate surface (step S42).

Next, similarly to the above-described step S03, a multilayer structure body is formed by depositing films on the platinum substrate 23 after the etching process by a sputtering method using an argon beam.

Furthermore, a multilayer structure body 102 is formed by addition of a Cs layer that undergoes nuclide transmutation on the film deposited surface of the multilayer structure body 11 by electrolysis of the D₂O diluted solution of CsNO₃ (CsNO₃/D₂O solution) (step S44).

The desorption chamber 103 and the absorption chamber 101 is closed so as to be airtight after the Cs layer of the multilayer structure body 102 is directed towards the absorption chamber 103. Then, the valve 105 is closed, the vacuum valve 108 in the connecting pipe 109 is opened, and the desorption chamber 101 and the absorption chamber 103 are evacuated using the rotary pump 111 and the turbo-molecular pump 110 (step S45).

Subsequently, after the multilayer structure body 102 is heated to, for example, 70° C. by a heating device (not shown), the vacuum valve 108 is closed and evacuation of the absorption chamber 103 is stopped. Then, deuterium gas is introduced into the absorption chamber 103 at a predetermined pressure and the experiment of the nuclide transmutation is commenced. The predetermined pressure at the time of introducing the deuterium gas is regulated by the regulator valve 104, and the pressure is determined, for example, to be 1.01325×10⁵ (1 atm) (step S46).

The amount of the deuterium gas discharged in the desorption chamber 101 is calculated based on the degree of vacuum detected by, for example, the vacuum gauge 112 and the flow rate of the turbo-molecular pump 110.

After several tens of hours after starting introduction of the deuterium gas in the absorption chamber 103, the temperature of the multilayer structure body 102 is returned to room temperature. The valve 105 is closed and after stopping the introduction of the deuterium gas into the absorption chamber 103, the absorption chamber 103 is evacuated and the nuclide transmutation experiment is completed (step S47).

The multilayer structure body 102 is taken out from the nuclide transmutation chamber 100 and the multilayer structure body 102 is etched by aqua regia for preparing a solution which contains the elements present on the surface of the multilayer structure body 102. This solution is analyzed by a ICP-MS (Inductive Coupled Plasma-Mass spectrometry) for quantitative analysis of the elements present on the surface of the multilayer structure body 102 (step S48).

Below, the results of two repeated experiments by the same method, that is, the experiments 11 and 12, based on the same nuclide transmutation method according to the above-described embodiment of the present invention are described.

In the following Table 3, the results of the ICP-MS analyses for two samples obtained in the examples 11 and 12 are described.

TABLE 3

| | Pr | Cs |
|---|---|---|
| Example 11 | 1.3 μg | 2.3 μg |
| Comparative Example | 0.008 μg | 3.8 μg |
| Example 12 | 0.12 μg | — |

As shown in Table 3, it was found that the contents of Pr and Cs were 0.008 mg and 3.8 μg, respectively, in the solution of the comparative example, which is obtained from the multilayer structure body 102 before starting the experiments

In contrast, after the experiments of the nuclide transmutation, the content of Pr is increased to 1.3 μg, which is more than 100 times greater than the initial weight, and the content of Cs is decreased to 2.3 μg.

In the experiment 12, the content of Pr increases to 0.12 μg, which corresponds to a weight more than ten times greater than the initial weight.

Consequently, it is concluded that the above results indicate that the increase of Pr observed in examples 11 and 12 is caused by the nuclide transmutation from Cs to Pr.

As described above, although the nuclide transmutation device 100 according to the present invention has a relatively small-scale structure, it is confirmed that the present nuclide transmutation device is able to carry out nuclide transmutation instead of using large sacle systems such as a nuclear reactor or a particle accelerator.

In addition, in spite of the fact that the present nuclide transmutation device and the multilayer structure body differ from the nuclide transmutation device 30 and the multilayer structure body according to the first embodiment, both of the nuclide transmutation devices and multilayer structure bodies are confirmed to be able to carry out the nuclide transmutation such as from Cs to Pr successfully, which results in showing the substantial effectiveness of the present invention.

In addition, in the first embodiment, the second embodiment, and the third embodiment of the present invention described above, palladium (Pd) was used as the metal for absorbing the hydrogen, but the invention is not limited thereby, and a Pd alloy, or, for example, another metal that absorbs hydrogen, such as Ti, Ni, V, or Cu, or an alloy thereof can be used.

As explained above, according to the first aspect of the nuclide transmutation device of the present invention, nuclide transmutation can be carried out with a relatively small-scale device compared to the large-scale devices such as accelerators and nuclear reactors, a pressure differential in the deuterium between the one surface and the other surface of the structure body is provided, and within the structure body a flux of deuterium from one surface side to the other surface side is produced, and thereby an easily reproducible nuclide transmutation reaction can be produced for the deuterium and the material that undergoes nuclide transmutation.

Furthermore, according to the second aspect of the nuclide transmutation device of the present invention, the absorption part is pressurized by the deuterium supply device, and at the same time, the pressure in the radiation part is reduced to a vacuum state by the exhaust means, and thus a pressure differential in the deuterium is formed in the structure body.

Furthermore, according to the third aspect of the nuclide transmutation device of the present invention, by electrolyzing the electrolytic solution on one surface of the structure body with the structure body serving as a cathode, deuterium is absorbed effectively into the structure body due to the high pressure, and by reducing the pressure of the radiation part to a vacuum state using the exhaust device, a pressure differential in the deuterium is formed in the structure body.

Furthermore, according to the fourth aspect of the nuclide transmutation device of the present invention, the transmutation material lamination device can laminate the material that undergoes the nuclear transmutation on one surface of the structure body by a surface forming process, such as electrodeposition, vapor deposition, or sputtering.

Furthermore, according to the fifth aspect of the nuclide transmutation device of the present invention, the material that undergoes nuclide transmutation can be bound to one surface of the structure body by mixing the material that undergoes nuclide transmutation in, for example, a gas or liquid that includes deuterium.

Furthermore, according to the sixth aspect of the nuclide transmutation device of the present invention, a mixed layer that includes a material having a low work function is provided on the structure body that serves as the multilayer structure, and thereby the repeatability of the production of the nuclide transmutation reaction is improved.

Moreover, according to the first through sixth aspects of the nuclide transmutation device of the present invention, the production of the nuclide transmutation reaction can be further promoted by transmuting the material that undergoes nuclide transmutation to a nuclide having a similar isotope ratio composition, and the repeatability of the generation of the nuclide transmutation reaction can be improved.

In addition, according to the seventh aspect of the nuclide transmutation device of the present invention, a flux of deuterium from the one surface side to the other surface side within the structure body is produced, and thereby the nuclide transmutation reaction is produced with good repeatability for the deuterium and the material that undergoes nuclide transmutation.

Furthermore, according to the eighth aspect of the nuclide transmutation method of the present invention, a material that undergoes nuclide transmutation is laminated on the one surface of the structure body by a film formation process using a transmutation material lamination process such as electrodeposition, vaporization deposition, or sputtering, or the material that undergoes nuclide transmutation is mixed with a gas or liquid that includes deuterium and the like, and thereby the material that undergoes the nuclide reaction is bound to the one surface of the structure body.

Furthermore, according to the ninth aspect of the nuclide transmutation method of the present invention, the material that undergoes nuclide transmutation is transmuted to a nuclide having a similar isotopic ratio composition, and thereby the nuclide transmutation reaction can be promoted, and the repeatability of the generation of the nuclide transmutation reaction can be improved

1. A nuclide transmutation device for achieving a nuclide transmutation, comprising:
a multilayer structure body; that is made of palladium, or a palladium alloy, or a hydrogen absorbing metal other than palladium, or a hydrogen absorbing alloy other than a palladium alloy,
an absorption part and a desorption part that are disposed so as to surround said multilayer structure body on the sides and form a closed space that can be sealed by said multilayer structure body;
a high pressurization device that produces a relatively high pressure of deuterium at said absorption part on the side of the surface of said multilayer structure body; and
a low pressurization device that produces a relatively low pressure of deuterium at said desorption part on the other side of the surface of said multilayer structure body,
wherein
said multilayer structure body includes:
i) a base material including a hydrogen absorbing metal or a hydrogen absorbing alloy;
ii) a mixed layer formed on said base material and comprising a hydrogen absorbing metal or a hydrogen absorbing alloy, and a material having a low work function that allows emission of electrons equal to or less than 3 eV;
iii) a surface layer formed on said mixed layer and comprising a hydrogen absorbing metal or a hydrogen absorbing alloy; and
iv) an additional layer bound on the surface of said surface layer and that undergoes nuclide transmutation,
said high pressurization device includes a deuterium gas supply device configured to supply the deuterium gas into said absorption part so that said additional layer that undergoes nuclide transmutation is exposed to the deuterium gas and a flow of the deuterium that penetrates through the multilayer structure body is provided.

2. A nuclide transmutation device according to claim 1, wherein said additional layer that undergoes nuclide transmutation includes at least one of Cs, C, Sr, and Na.

3. A nuclide transmutation device according to claim 2, wherein said low pressurization device comprises an exhaust device which evacuates said desorption part.

4. A nuclide transmutation device according to claim 3, wherein said base material is formed by Pd, said mixed layer is formed by Pd and a material having a work function equal to or less than 3 eV, and said surface layer is formed by Pd.

5. A nuclide transmutation device according to claim 4, wherein said mixed layer comprises layers of Pd and layers of CaO that are laminated alternately.

6. A nuclide transmutation device according to claim 5, wherein a heating device for controlling the temperature of the multilayer structure body is provided.

7. A nuclide transmutation method using the nuclide transmutation device according to claim 6, comprising the step of:
a low pressurizing process that brings about a state in which the pressure of the deuterium is relatively low on the other surface side of said multilayer structure body,
wherein
the method further comprises a high pressurizing process of supplying a deuterium gas from said deuterium gas supply device into said absorption part so that the surface of said additional layer that undergoes nuclide transmutation is exposed to the deuterium gas, and
providing a flow of the deuterium that penetrates through the multilayer structure body.
